(19) United States
(12) Patent Application Publication
(10) Pub. No.: US 2025/0346166 A1
(43) Pub. Date: Nov. 13, 2025

(54) MULTI-PIVOT SEAT BASE ASSEMBLY

(71) Applicant: DEMERS, AMBULANCE MANUFACTURER INC./ DEMERS, MANUFACTURER D'AMBULANCES INC., Beloeil (CA)

(72) Inventors: Gilbert Dubocquet, Saint-Jean-Sur-Richelieu (CA); Hélène Trahan, Beloeil (CA); Martin Laliberté, Beloeil (CA); Yannick Tassé, McMasterville (CA); Carl Grégoire, Saint-Julie (CA); Gabriel Renaud, Beloeil (CA); Patrick Bérubé, Sainte-Madeleine (CA); Philippe Noel, Beloeil (CA); Stéphane Poulin, Saint-Julie (CA); Vincent St-Pierre, Saint-Hyacinthe (CA)

(21) Appl. No.: 18/872,080

(22) PCT Filed: Jun. 14, 2023
(86) PCT No.: PCT/IB2023/056166

§ 371 Date: Dec. 5, 2024

Related U.S. Application Data
(60) Provisional application No. 63/352,467, filed on Jun. 15, 2022.

(51) Int. Cl. B60N 2/90; A61G 3/00; B60N 2/14

(52) U.S. Cl. CPC B60N 2/938; A61G 3/00; B60N 2/14; B60N 2002/952

(57) ABSTRACT

A multi-pivot seat base assembly includes a first pivot assembly mountable to a floor, a proximate arm having a proximate end mounted to the first pivot assembly and a distal end mounted to a second pivot assembly, a distal arm having a proximate end mounted to the second pivot assembly; the distal arm including a distal end provided with a third pivot assembly defining a seat receiving element. First and second pivot locking assemblies are provided to lock the first, second and the third pivot assemblies, respectively.

### FIELD

The present disclosure relates to seat bases. More specifically, the present disclosure is concerned with a multi-pivot seat base assembly.

### BACKGROUND

Many vehicles, such as emergency vehicles and transport vehicles, are provided with seats that are fixedly mounted to the floor of the vehicle via seat bases.

In some cases, the seat bases are mounted onto tracks, fixed on, above or embedded in the floor of the vehicle, to allow some restricted movements of the seat occupants. These tracks have many drawbacks, including the fact that foreign matter may be stuck therein and prevent desired movements or that each axis of movement requires a different release mechanism, making repositioning a multi-movement operation. Furthermore, they can become trip hazards.

### SUMMARY

According to an illustrative embodiment, there is provided a multi-pivot seat base assembly including:

a floor-mountable element;

a proximate arm having proximate and distal ends; the proximate arm being mounted to the floor-mountable element via its proximate end for first relative pivotal movement between the proximate arm and the floor-mountable element;

a distal arm having proximate and distal ends; the distal arm being mounted via its proximate end to the distal end of the proximate arm for second relative pivotal movement between the distal and proximate arms;

a seat-mounting element mounted to the distal arm at the distal end thereof for third relative pivotal movement between the distal arm and the seat mounting element;

a first pivot locking assembly associated with the proximate arm and being so configured as to selectively prevent the first relative pivotal movement;

a second pivot locking assembly associated with the distal arm and being so configured as to selectively prevent the third relative pivotal movement; and

a third pivot locking assembly associated with one of the proximate and distal arms and being so configured as to selectively prevent the second relative pivotal movement.

Other objects, advantages and features of the multi-pivot seat base assembly will become more apparent upon reading the following non-restrictive description of preferred embodiments thereof, given by way of example only with reference to the accompanying drawings.

### BRIEF DESCRIPTION OF THE DRAWINGS

In the appended drawings:

FIG. 1 is a top plan view of a seat provided with a multi-pivot base according to a first illustrative embodiment, shown in three different positions;

FIG. 2 is a perspective view of a multi-pivot base according to a first illustrative embodiment;

FIG. 3 is a perspective view of the multi-pivot base of FIG. 2, shown in transparency;

FIG. 4 is a perspective view of the multi-pivot base of FIG. 2, shown in a partially deployed position;

FIG. 5 is a perspective exploded view of the multi-pivot seat base assembly of FIG. 2;

FIG. 6 is a perspective view of the first pivot locking mechanism of the multi-pivot base of FIG. 2 and of an arm movement coupling assembly according to a first illustrative embodiment;

FIG. 7 is a sectional view taken along line 7-7 of FIG. 6;

FIGS. 8 and 9 are bottom plan views of the first pivot locking mechanism from FIG. 6, shown respectively in locked and unlocked positions;

FIG. 10 is a perspective view of the second pivot locking mechanism of the multi-pivot base of FIG. 2, shown in a locked position;

FIG. 11 is a perspective view similar to FIG. 10, shown in an unlocked position;

FIG. 12 is a sectional view taken along line 12-12 of FIG. 10;

FIG. 13 is a sectional view taken along line 13-13 of FIG. 11;

FIG. 14 is a top plan view of the interior of an ambulance compartment provided with three seats each mounted to a multi-pivot base as illustrated in FIG. 2; each seat being shown in its neutral position and in two possible positions;

FIG. 15 is a top plan view, similar to FIG. 14, but illustrating the three seats in alternate possible positions;

FIG. 16 is a perspective exploded view of a multi-pivot seat base assembly according to a second illustrative embodiment;

FIGS. 17 and 18 are top plan views of the first pivot locking mechanism according to a second illustrative embodiment, shown respectively in locked and unlocked positions;

FIG. 19 is a perspective view of the first pivot locking mechanism from FIGS. 17 and 18, showing parts thereof out of a housing body adapted therefor;

FIGS. 20 and 21 are top plan views of the second pivot locking mechanism according to a second illustrative embodiment, shown respectively in locked and unlocked positions; and

FIG. 22 is a perspective view of the second pivot locking mechanism from FIGS. 18 and 19, showing parts thereof out of a second housing body adapted therefor.

### DETAILED DESCRIPTION

In the following description, similar features in the drawings have been given similar reference numerals, and in order not to weigh down the figures, some elements are not referred to in some figures if they were already identified in another figure.

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

In the present specification and in the appended claims, various terminologies which are directional, geometrical and/or spatial in nature such as “longitudinal”, “horizontal”, “front”, rear”, “upwardly”, “downwardly”, etc. is used. It is to be understood that such terminologies are used for ease of description and in a relative sense only and is not to be taken in any way as a limitation upon the scope of the present disclosure.

The expression “connected” should be construed herein and in the appended claims broadly to include any cooperative or passive association between mechanical parts or components. For example, such parts may be assembled together by direct coupling, or indirectly coupled using further parts.

The expressions “ball bearing” and “bearing” will be used herein interchangeably.

It is to be noted that while the present detailed description refers to an emergency vehicle such as an ambulance, other vehicles using for example seats that are fixedly or adjustably mounted to a floor using a base can be provided with a multi-pivot base as described herein.

Other objects, advantages and features of the multi-pivot seat base assembly will become more apparent upon reading of the following non-restrictive description of illustrative embodiments thereof, given by way of example only with reference to the accompanying drawings.

Generally stated, an illustrative embodiment is concerned with a multi-pivot seat base assembly designed to be fixed to the floor of a vehicle. The multi-pivot base includes proximate and distal arms hinged together by pivots and optional mechanisms allowing their movements to be coordinated. Furthermore, first, second and third pivot locking mechanisms are provided to allow an automatic lock of the multiple pivots. These locks may be controlled by the user or by a controller (not shown) when a position change is required.

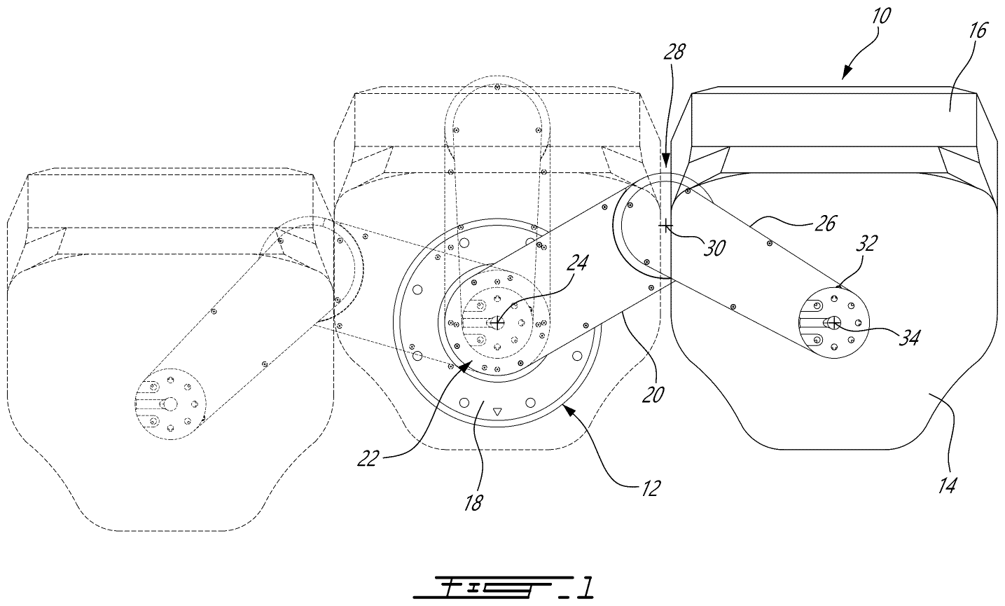

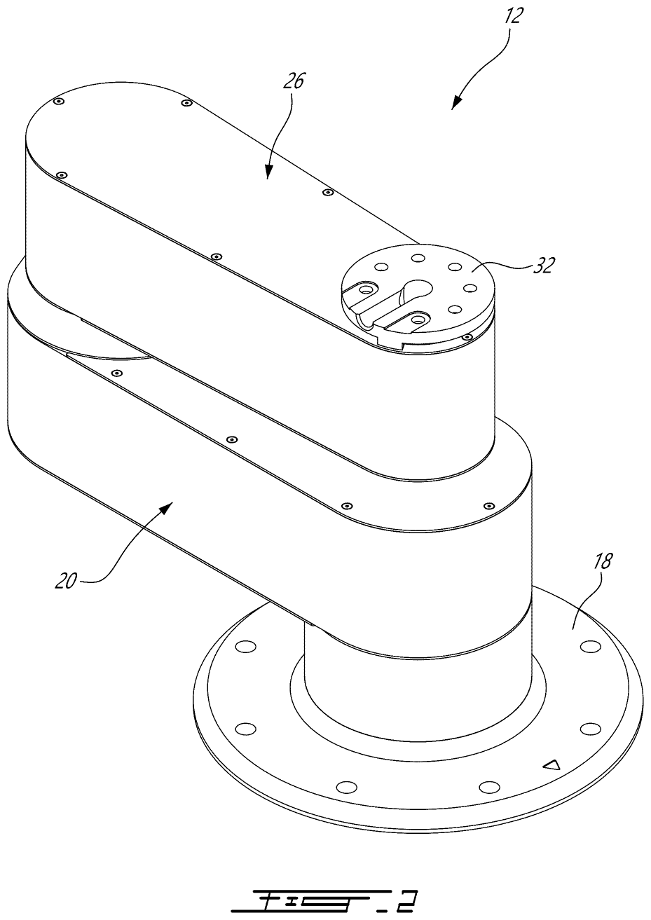

FIG. 1 of the appended drawings illustrates a seat 10 mounted to a multi-pivot seat base assembly 12 according to a first illustrative embodiment. According to the first illustrative embodiment, the seat assembly 10 conventionally includes a seat 14 and a back rest 16. According to another illustrative embodiment (not shown), the seat assembly does not include a backrest. More generally, the seat assembly includes any features or take any shape and configuration allowing a person to sit.

The multi-pivot seat base assembly 12 includes a floor-mountable element in the form of a generally circular anchoring plate 18, configured to be fixedly mounted to the floor (not shown), a proximate arm 20 mounted to the anchoring plate 18 via a first pivot assembly 22 for pivotal movement relative to the anchoring plate 18 about a first pivot axis 24, a distal arm 26 so mounted to the proximate arm 20 via a second pivot assembly 28 provided between the proximate and distal arms 20 and 26, for pivotal movement relative to the proximate arm 20 about a second pivot axis 30. A seat-receiving element 32 is mounted to the free end of the distal arm 26 via a third pivot assembly 33 for pivotal movement relative thereto about a third pivot axis 34.

It is to be noted that the expression seat-receiving element should be construed in the description and in the claims as including an attachment part configured to receive a seat or any part of a seat configured to be attached generally to a seat base or support.

As will be described hereinbelow in more detail, according to the first illustrative embodiment, the first and second pivot assemblies 22 and 28 are so coupled to cause the proximate and distal arms 20 and 26 to pivot in unison, respectively about the first and second pivot axes 24 and 30.

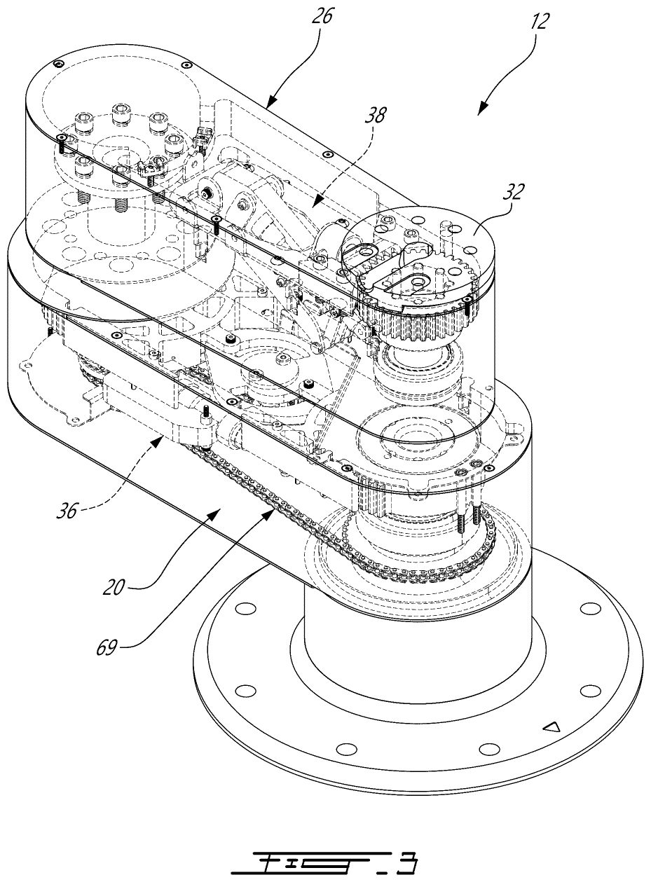

As can be seen from FIG. 3, the multi-pivot seat base assembly 12 also includes a controllable first pivot locking assembly 36 mounted to the proximate arm 20 and associated with the first and second pivot assemblies 22 and 28 to selectively prevent both the proximate and distal arms 20 and 26 from pivoting. A controllable second pivot locking assembly 38, mounted to the distal arm 26 and associated with the third pivot assembly 33, is provided to prevent the seat-receiving element 32 from pivoting relative to the distal arm 26 as will be described herein.

FIG. 1 also illustrates, in dashed lines, two out of multiple possible positions of the seat 10 with respect to the anchoring plate 18.

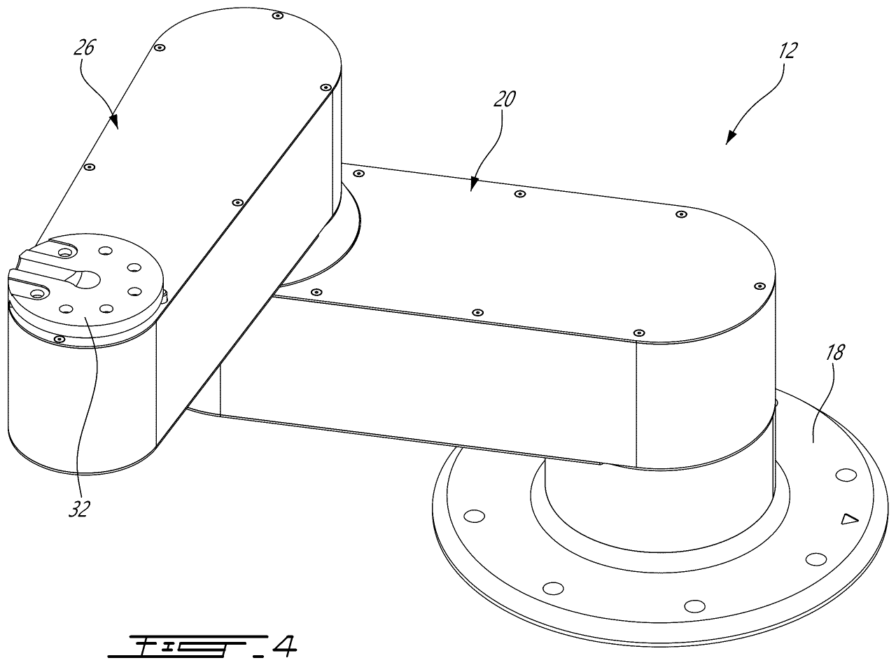

Turning now first to FIG. 5 of the appended drawings, the various elements of the multi-pivot seat base assembly 12 will be described in greater details.

Starting from the bottom, the anchoring plate 18 is designed to be mounted to the floor (not shown) and can take any form allowing such function. The first pivot assembly 22 includes a shaft 35 having an integral flange 37 at its bottom end, and a spacer 40 mounted about the shaft 35 and secured to the flange 37 thereof using fasteners 46. The spacer 40 is mounted to the plate 18 via fasteners 42. The free end of the shaft 35 includes eight (8) semi-cylindrical grooves 48 and an external thread 50.

The proximate arm 20 includes a body 52 closed by a bottom cover 54 and a top cover 56. The body 52 and the bottom cover 54 are so configured as to allow the shaft 35 of the first pivot assembly 22 therethrough. The shaft 35 may thus reach the first pivot locking assembly 36, which is mounted in the body 52 as will be described hereinbelow in more detail. distal arm 26.

A spacer 58 is provided between the proximate arm 20 and the

The second pivot assembly 28 includes a shaft 29 having an integral flange 31 at its top end. The distal arm 26 includes a body 60 closed by a bottom cover 62 and a top cover 64. The body 60 and the bottom cover 62, as well as the top cover 64 of the distal arm 26 are so configured as to allow the shaft 29 of the second pivot assembly 28 therethrough to reach the first pivot locking assembly 36. The third pivot assembly 33 is in the form of a shaft that is integral the seat-receiving element 32, coaxially thereto. The body 60 and top cover 64 are configured to allow the shaft 33 therethrough to reach the second pivot locking assembly 38. The second pivot locking assembly 38 will be better described hereinbelow.

As can be seen from this figure, the free end of the shaft 29 of second pivot assembly 28 includes eight (8) semi-cylindrical grooves 66 and is threaded. Similarly, the free end of the third pivot 32 includes eight (8) semi-cylindrical grooves (not shown).

It will be appreciated by one skilled in the art, that many fasteners are required to assemble the above-described parts.

The proximate and distal arms are not limited to the illustrated embodiment and may have many other shapes allowing to operatively include pivot assemblies as described hereinabove or allowing the same relative movements of proximate and distal arms, and of floor-mounting and seat-receiving elements.

With reference to FIGS. 3, 5, 6 and 7, an arm coupling assembly 69, that links both proximate and distal arms 20 and 26 so that the proximate and distal arms 20 and 26 are caused to pivot in unison, will now be described in more detail.

The coupling assembly 69 includes a first sprocket 70 configured to be fixedly mounted to the spacer 40 via pins 72, a second sprocket 74 that is mounted to the end of the second shaft 29 via fasteners 76, and a chain 78 engaged to both sprockets 70 and 74. The first sprocket 70 includes a central aperture 71 so configured and sized as to let the first shaft 35 therethrough.

One skilled in the art will understand that since the first sprocket 70 is so mounted to the first pivot assembly 22 via the spacer 40 and since the second sprocket 74 is so mounted to the second pivot assembly 28 as to pivot therewith, a pivotal movement of the distal arm 26 about the second pivot axis 30 causes a pivotal movement of the proximate arm 20 about pivot axis 24.

It is believed to be within the skills of one skilled in the art to determine the gear ratio between the first and second sprockets 70 and 74 to obtain the desired movement pattern.

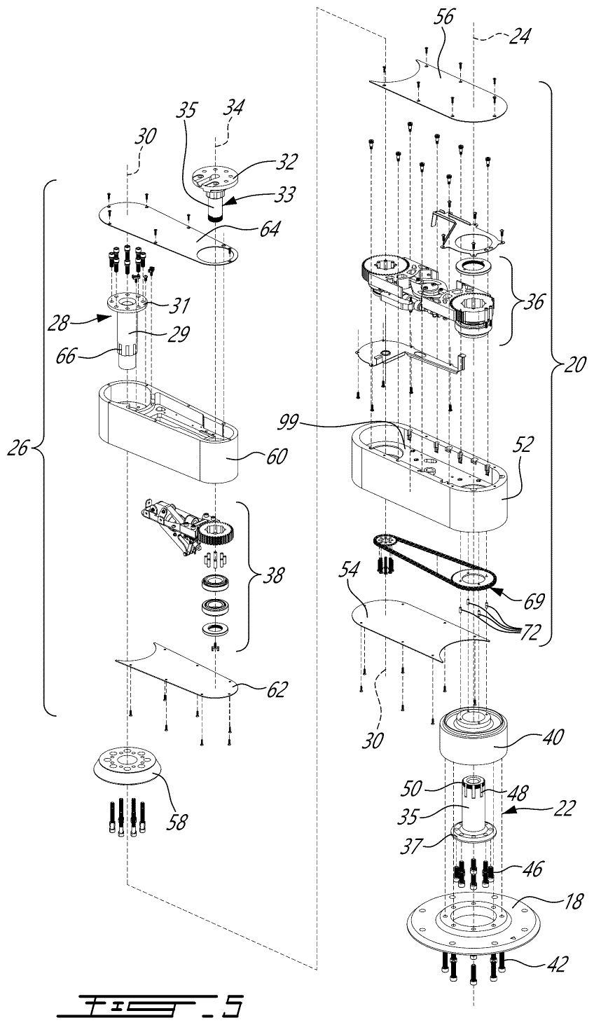

Turning now to FIGS. 6 to 9, the first pivot locking assembly 36 will be described. The first pivot locking assembly 36 is provided to automatically prevents the arms 20 and 26 from pivoting unless the user manually and momentarily disengages the lock as will be described hereinbelow.

The first pivot locking assembly 36 includes a first locking gear 80, including a meshing side 93 oriented towards the longitudinal center of the arm 20 and a mounting side 95 longitudinally opposite the meshing side 93. The mounting side 93 abuts two fastener-receiving cylindrical portions 97 that are mounted to the body 52 within the cavity 99 so as to be positioned radially outward from the gear 80 and that are attached via fasteners 82. The protruding portions 97 further defines mechanical stops to limit the pivotal movement of the proximate arm 20 in both directions.

A second locking gear 84 is provided, which does not require mechanical stops. Both locking gears 80 and 84 include a central aperture 86, 88 provided with semi-cylindrical grooves 89 similar to grooves 48 and 66 of the first and second pivot shaft 35 and 29. Pins 90 are provided in the semi-cylindrical grooves to prevent pivotal movements between the respective pivot assemblies 22, 28 and the locking gears 80 and 84. A locking ring or nut 92 is further provided to securely mount the proximate arm 20 to the shaft 35 of the pivot assembly 22.

The first pivot locking assembly 36 also includes first and second locking elements 94 and 96 that are movable towards and away from respective locking gears 80 an 84 as will be described hereinbelow. The locking elements 94 and 96 include toothed portions that are configured and sized as to be meshed with respective locking gears 80 and 84 and straight sides 98 that are configured to slide along the internal walls of the body 52 to prevent non-longitudinal movements of the elements 94 and 96 with respect to the body 52.

As can be seen partially from FIG. 5, the body 52 is configured with top and bottom side cavities (only the top side 99 shown in FIG. 5), which are configured to operatively receive the first pivot locking assembly 36, the arm coupling assembly 69 and parts of both the first and second pivot assemblies 22 and 30.

The first pivot locking assembly 36 further includes an actuating mechanism in the form of a powered cam assembly 100 that is so mounted to the body 52 and to the locking elements 94 and 96 as to move the locking elements 94 and 96 towards or away from respective locking gears 80 and 84. The cam slots 104 and 106 are shaped to allow locking elements 94 and 96 to engage independently from one another and once both locking elements 94 and 96 are in place, cam 102 will complete its rotation and secure locking elements 94 and 96 in locked position.

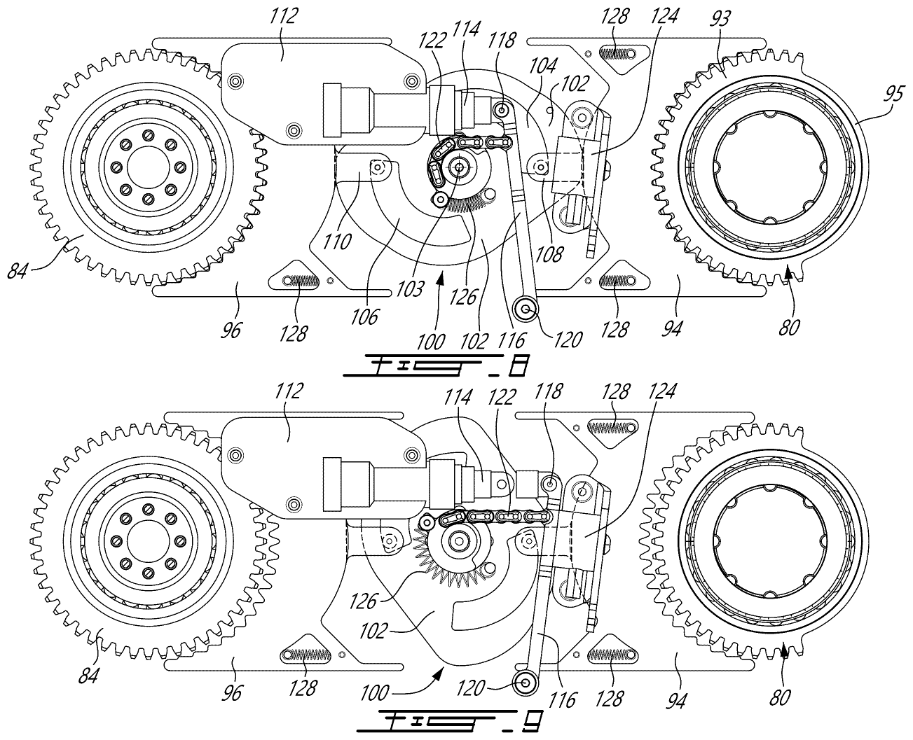

As can be better seen from FIGS. 8 and 9, the powered cam assembly 100 includes a cam 102, pivotable about axis 103, and provided with curved slots 104 and 106 that are configured to receive respective arms 108 and 110 of the locking elements 94, 96.

One skilled in the art will understand that pivotal movements of the cam 102 about axis 103, in the appropriate direction, forces the disengagement of the locking elements 94, 96 onto respective locking gears 80, 84.

The cam slots 104 and 106 are shaped to allow locking elements 94 and 96 to engage independently from one another, and once both locking elements 94 and 96 are in place, cam 102 will complete its rotation and secure locking elements 94 and 96 in locked position.

To selectively rotate the cam 102, the powered cam assembly 100 is further provided with an actuator piston 112. The actuator 112 is provided with a piston 114 connected to the first end 118 of a link 116 having a second end 120 that is pivotally mounted to the body 52 in the cavity 99. A short chain 122 interconnects the link 116 to the cam 102 so that the movements of the piston 114 cause pivotal movements of the cam 102. The actuator piston 112 can be hydraulic, pneumatic or electric.

According to another illustrative embodiment (not shown), another actuator than the actuator piston 112 can be used, such as for example, a linear or rotary actuator.

FIG. 8 shows the locking elements 94 and 96 in locking relationship with respective locking gears 80, 84, while FIG. 9 shows the locking elements spaced 94 and 96 spaced apart from the locking gears 80 and 84.

To selectively maintain the first pivot locking assembly 36 in its unlocked state shown in FIG. 9, the mechanism 36 further includes an electromagnet 124 that is selectively energized to maintain the link 116 in the unlocked position and therefore maintain the unlocked state even when the piston cylinder 112 is no longer energized.

One skilled in the art will understand that the electromagnet 124 could be replaced by other suitable mechanical arrangements (not shown) serving the same purpose.

Biasing elements, in the form of springs 126 and 128 are provided to force the locking elements 94 and 96 towards respective locking gears 80, 84 when the electromagnet 124 is de-energized. More specifically, one spring 126 interconnects the cam 102 to the body 52 and four (only three shown) springs 128 interconnect the locking elements 94 and 96 to the body 52. Springs 126 and 128 ensure that the pivots are locked by default.

The first and second pivot locking assembly is not limited to the first illustrative embodiment 36. For example, another actuating mechanism than the piston 114 can be provided. Also, other active or passive biasing members or assemblies than the spring 126, 128 and electromagnet 124 can be provided. The coupling mechanism between the actuating mechanism and locking element 94 can also be different than the illustrated mechanism. Finally, the coupling elements between the first pivot locking assembly and first and second pivot assemblies 22, 28 are not limited to the illustrated gears 80, 84 and locking elements 94, 96.

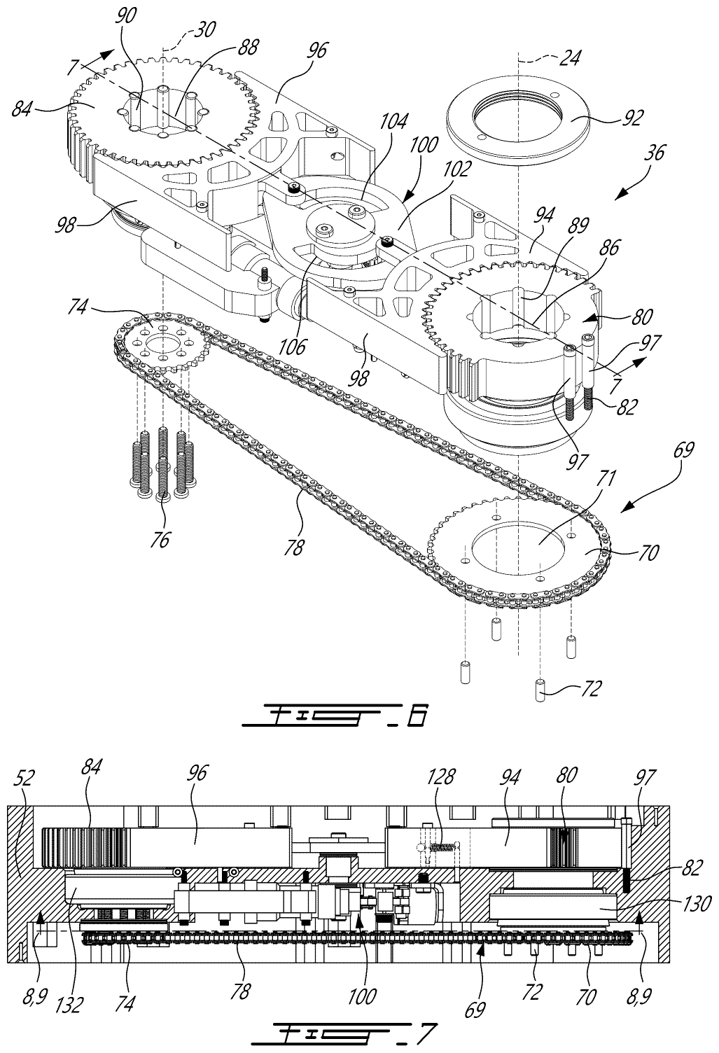

As can be seen from FIG. 7, bearings 130 and 132 are provided in the body 52 between the sprockets 70, 74 and the first locking mechanism 36 to facilitate the pivotal movements between the proximate arm 20 and the pivot assemblies 22 and 28.

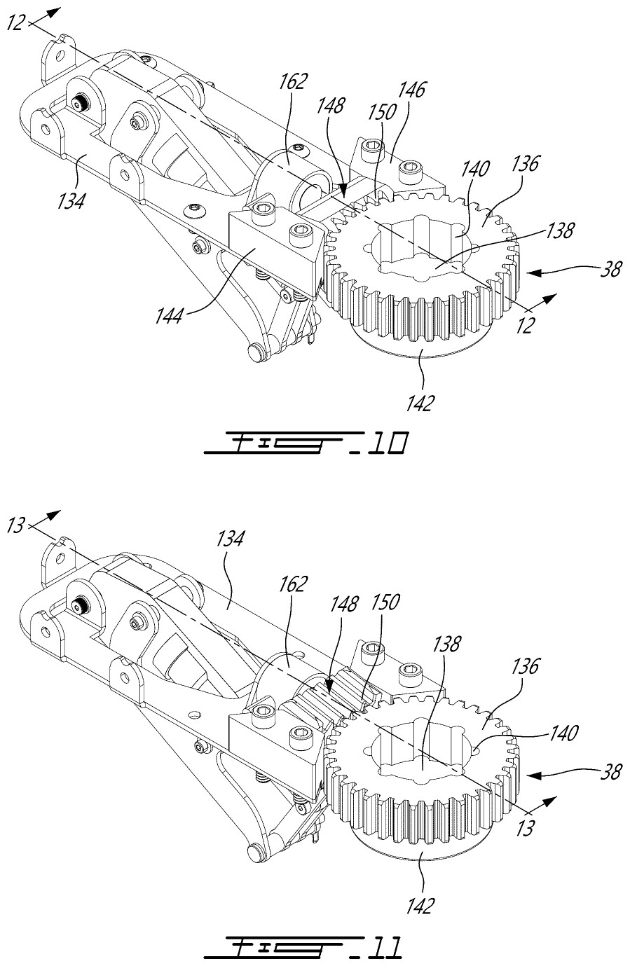

Turning now to FIGS. 10 to 13, the second pivot locking assembly 38 will be described.

The general purpose of the second pivot locking assembly 38 is to selectively lock the third pivot assembly 32 to prevent the pivoting thereof.

The second pivot locking assembly 38 includes a frame 134 configured to be mounted to the body 60 of the distal arm 26, and a locking gear 136 provided with a central opening 138 operatively configured to receive the shaft 35 of the third pivot assembly 33 and including semi-cylindrical grooves 140. Pins (not shown) are provided in the semi-cylindrical grooves prevent pivotal movements between the shaft 35 and the locking gear 136. Two bearings 142 (only one shown) are further provided to pivotably receive the shaft 35 in the body 60.

Two support pieces 144 are mounted to the frame 134, adjacent the gear 136, having flat lateral portions to contact the internal surface of the body 60.

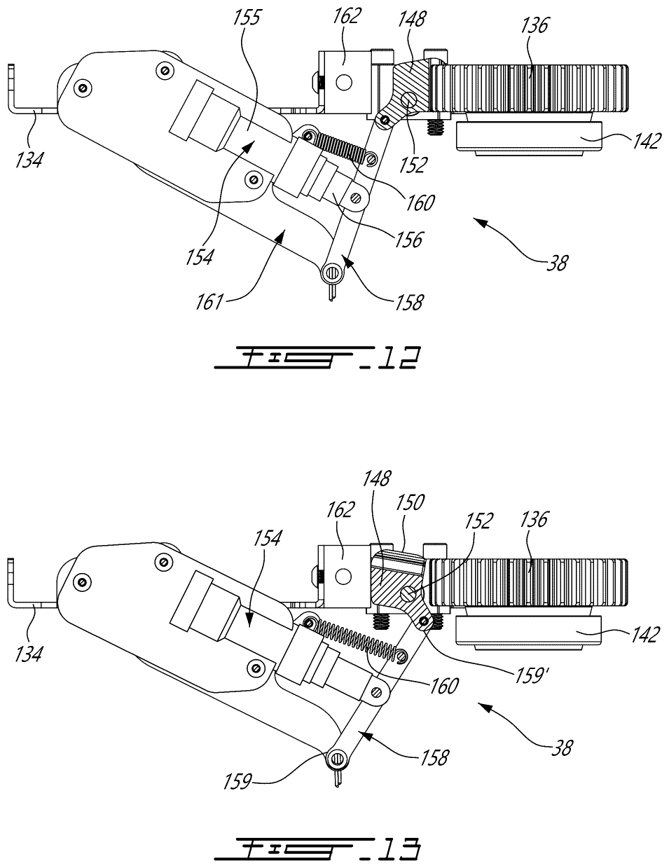

A locking element 148 including teeth 150 configured to be meshable with the locking gear 136 is pivotally mounted to and between the side pieces 144, 146 via a pivot pin 152 (see FIG. 12) for movement between locking and unlocking relationship with the gear 136.

As can be better seen from FIG. 12, the second pivot locking assembly 38 also includes an actuating mechanism in the form of a piston actuator 154 mounted to the frame 134. The piston 156 of the assembly 154 is coupled to the locking element 148 via a link 158 having a first end 159 pivotably mounted to the cylinder portion 155 of the actuator 154 via an L-shaped bracket 161 and a second end 159′ pivotably mounted to the locking element 148. The piston 156 is pivotably mounted to the link 158 at a position intermediary to both its ends 159-159′. A return spring 160 is mounted between the frame 134 and the link 158. Finally, an electromagnet 162 is so mounted to the frame 134 as to maintain the locking element 148 when it is energized.

FIGS. 10 and 12 show the second pivot locking assembly 38 in its locked configuration, i.e., when the piston actuator 154 is not powered and when the electromagnet 162 is not energized.

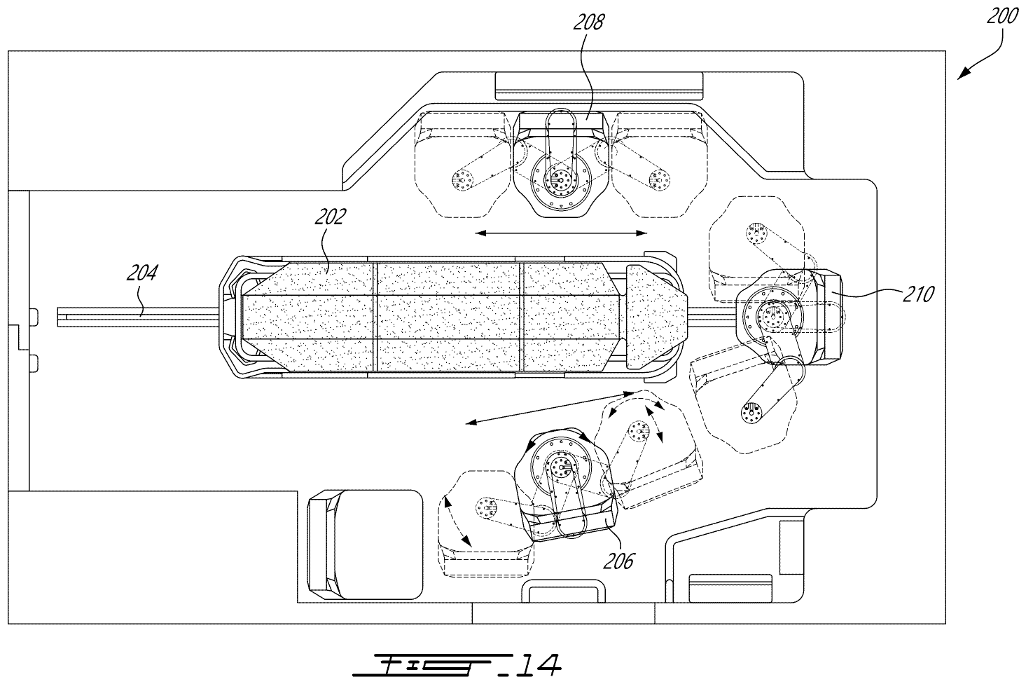

When the piston cylinder assembly 154 is powered, as shown in FIGS. 11 and 13, the piston 156 moves forward, therefore pivoting the link 158 which forces the locking element 148 to pivot about pivot 152, therefore disengaging the teeth 150 from the locking gear 136.

To selectively maintain the second pivot locking assembly 38 in its unlocked state shown in FIGS. 11 and 13 the electromagnet 162 is energized to maintain the locking element 148 and therefore maintain the unlocked state even when the piston actuator 154 is no longer energized.

One skilled in the art will understand that the then elongated spring 160 will force the locking element 148 back to its locking position when the electromagnet 162 is no longer energized.

The second pivot locking assembly 38 is not limited to the first illustrative embodiment 38. For example, another actuating mechanism than the piston actuator 154 can be provided. Also, other active or passive biasing members or assemblies than the spring 160 and electromagnet 162 can be provided. The coupling mechanism between the actuating mechanism 154 and locking element 148 can also be different than illustrated. Finally, the coupling elements between the locking mechanism 38 and third pivot assembly 33 is not limited to the illustrated gear 136 and locking element 148. For example, according to another illustrative embodiment (not shown), a ring mounted about the shaft 35 and a friction element or mechanism that can be selectively movable to contact the friction element, can alternatively be used.

Also, while the pivot assemblies 22, 28 and 33 are shown as including a shaft, anyone of these assemblies 22, 28 and 33 can be equipped with another pivotable element, such as a plate. Of course, in such cases, other coupling and locking elements than the illustrated sprockets and gears can be provided.

While not shown herein, a controller is used to actuate the piston cylinder assemblies 114 and 154 depending on inputs (not shown but can be viewed as a momentary switch) accessible to the user and parameters of the vehicle to which the multiple seat base is mounted. Parameters may include the speed of the vehicle, the state of the braking pedal of the vehicle, the state of the transmission and the state of the parking handbrake of the vehicle.

Generally stated, both locking mechanisms are in their locked position unless the user input is depressed by the user. However, the controller may be configured that in some cases, even the actuating of the user input does not unlock the locking mechanisms. As a non-limiting example, should the controller (not shown) determine that the vehicle is under hard braking or under hard acceleration, the controller prevent the unlocking of the locking mechanism even if the user input is used, for obvious safety purpose.

Otherwise, should the controller determine that it is safe to do so, upon actuation of the user input, both piston cylinder assemblies 114 and 154 are actuated and both electromagnets are energized, thereby unlocking the first and second locking assemblies 36 and 38, allowing the seat 206, 208 or 210 to pivot about pivot axis 34, the distal arm 26 to pivot about pivot axis 30 and the proximate arm 20 to pivot about axis 24.

When the user input is released by the user, the electromagnets 124 and 162 are de-energized, both piston cylinder assemblies 114 and 154 are retracted and the first and second locking assemblies 36 and 38 return to their locked states.

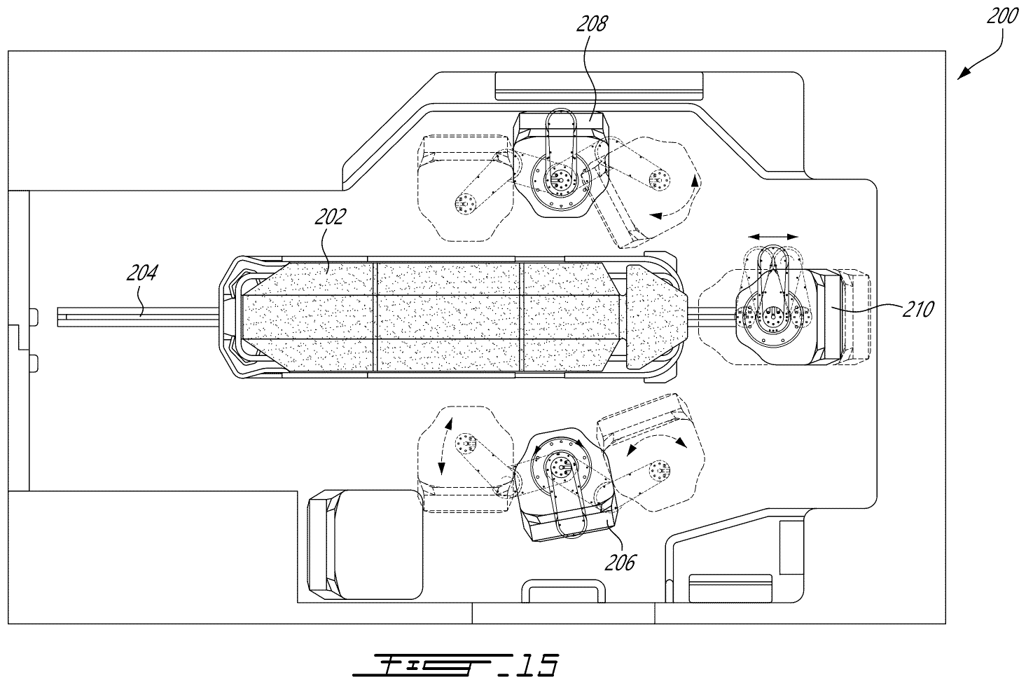

Turning now to FIGS. 14 and 15 of the appended drawings, possible movements of seats mounted to multi-pivot seat base assemblies will be illustrated in the context of an ambulance.

A conventional cot 202 is mounted to an elongated rail 204 to allow the conventional cot 202 to be positioned farther in the ambulance 200. The ambulance 200 includes three seats mounted to multi-pivot seat base assemblies as described herein. These seats are generally referred to as the curb-side seat 206, the street-side seat 208 and the head seat 210.

The elongated rail 204 allows the curb-side seat 206 and the street-side seat 208 to be positioned forward of the wheel wells (not shown) of the vehicle to thereby be on a flat portion of the ambulance floor and enable a greater freedom of movement for the seats. This seat positioning also allows the user to attend to the core and head of the patient present in the cot 202, thanks to the forward positioning of the cot 202 made possible by the elongated rail 204.

Each of FIGS. 14 and 15 shows three (3) possible positions for each of the seats 206, 208 and 210. As seen from these figures, the multi-pivot bases can be used to move towards and away from the cot, to move laterally and to turn around to reach equipment mounted onto horizontal surfaces or walls of the ambulance, as shown by the various arrows.

One skilled in the art will understand that even though three seats provided with a multi-pivot seat base mechanism as described herein are shown in FIGS. 14 and 15, only one or two of the seats shown could be provided with such a multi-pivot seat base assembly.

Similarly, while FIGS. 14 and 15 show an ambulance configuration where an elongated rail 204 allows the cot 202 to be positioned in a generally central location of the ambulance compartment 200, the multi-pivot seat base described herein could be used in a conventional ambulance layout and in other vehicles.

As will be obvious to those skilled in the art, other types of seats could be mounted to the multi-pivot seat base assemblies described herein.

One skilled in the art will understand that the sprockets 70 and 74, interconnected by the chain 78, could be omitted since the role of this arrangement, associated with the first pivot locking assembly 36, is to coordinate the position of the proximate and distal arms. Should a multi-pivot seat base assembly not require this coordination, these elements could be omitted. Of course, other arrangements, not shown, could be added to limit some movements of the proximate and/or distal arms.

While the first pivot locking assembly 36, mounted to the proximate arm 20, is shown associated with the first and second pivot assemblies 22 and 28, and the second pivot locking assembly 38, mounted to the distal arm 26, is shown associated with the third pivot assembly 32, a multi-pivot seat base assembly according to another illustrative embodiment (not shown) may include a locking mechanism mounted to the proximate arm 20 that is associated only with the first pivot assembly 22, and a second pivot assembly mounted to the distal arm that is associated with the second and third pivot assemblies.

The expression controllable, with reference to the first and second pivot locking assemblies 36 and 38, or to parts thereof, should be construed herein broadly as to include the result of a control initiated by a user or by a controller following reading of values from one or more sensors.

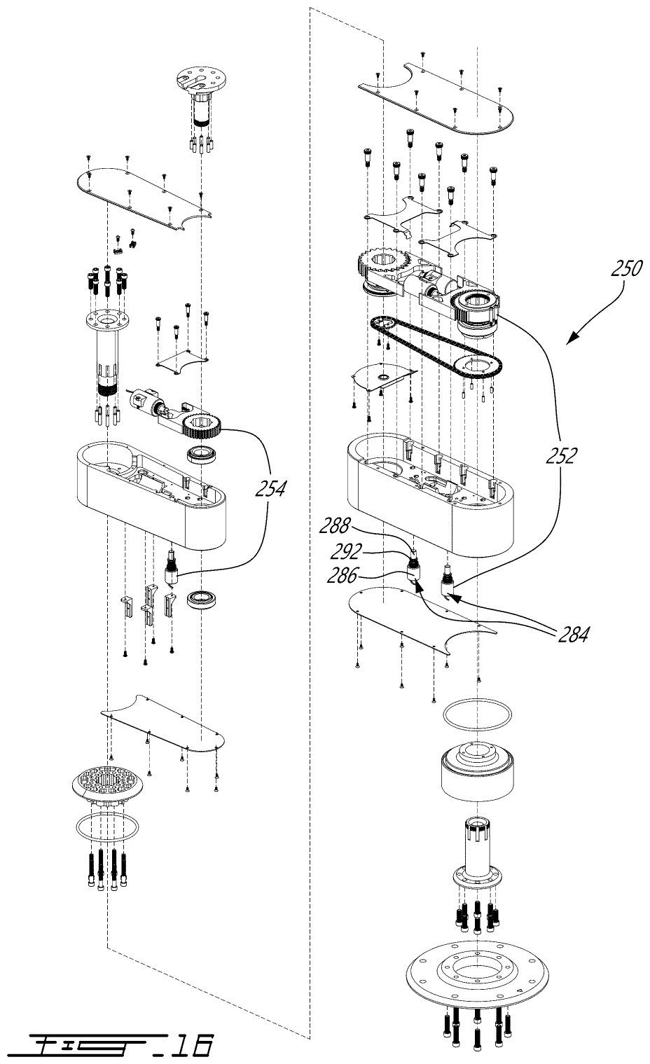

With reference first to FIG. 16, a multi-pivot seat base assembly 250 according to a second illustrative embodiment will now be described.

Since the assembly 250 is similar to the assembly 12, only the differences therebetween will be described herein in more detail for concision purposes.

As can be seen by comparing FIGS. 16 to FIG. 5, the main differences of the assembly 250 compared to the assembly 12 concern the first and second pivot locking mechanisms 252 and 254.

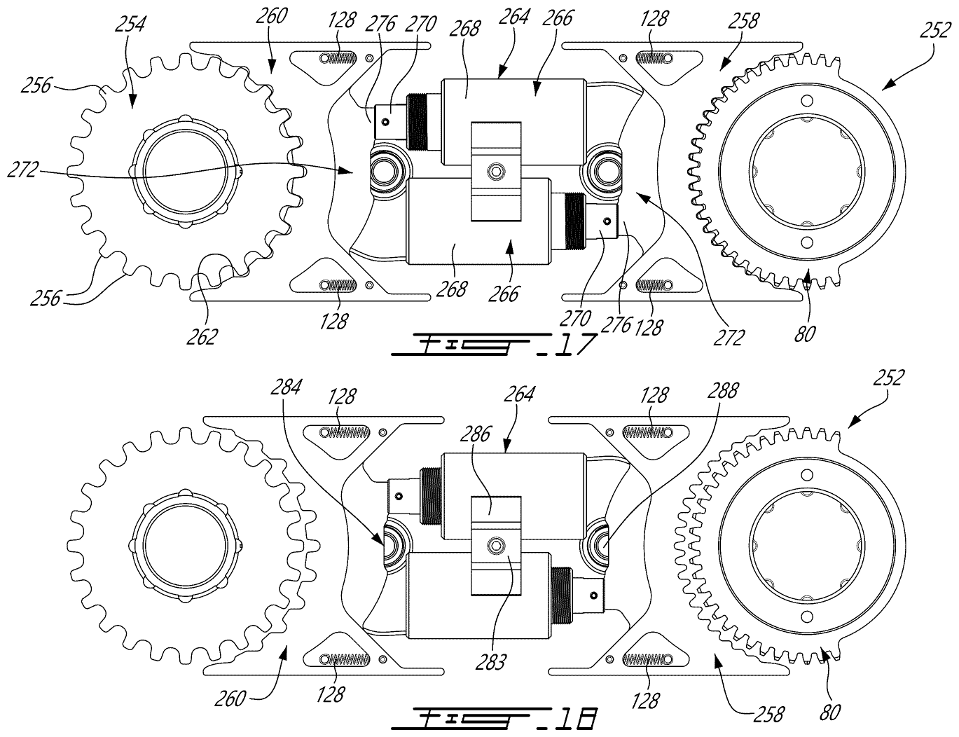

With reference to FIGS. 17-19, the first pivot locking mechanism 252 will now be described.

While the first locking gear 80 is identical to the one shown in FIG. 7, the second locking gear 254 has a smaller number of teeth 256 than the gear 84. Of course, the second locking element 260 includes a toothed side 262 that is configured and sized to be interlockable with the second locking gear 254.

Instead of the cam 102 and piston actuator 114, the actuating mechanism 264 comprises two linear solenoids 266, each including a main body 268 and a piston 270, that are mounted in parallel between both locking elements 258 and 260, but in opposite directions.

Each of the locking elements 258 and 260 includes an actuator cooperating portion 272 that is shaped for complementary receiving both actuators 266 thereon and therebetween. More specifically, each cooperating portion 272 includes a piston-receiving portion 276. Both cooperating portions 272 are oriented to be the mirror reflection across two axes to cooperate similarly with both actuators 266 considering that they are positioned parallel, with their pistons 270 facing a respective locking element 258, 260.

To prevent any undesired movements in a direction different than the operative directions of the actuators 266, the housing body 278 is configured with a top side cavity 280 that includes integrated rounded walls 282 that are configured to attach the actuators 266 in a way that restrains their main body 274. A top clamp 283, that is shaped to be complementary received between the main bodies 268 of both actuators 266 is attached to the housing body 278 using fasteners 286.

One skilled in the art will understand that operating together both actuators 266 so that their piston 270 are moved towards the locking elements 258 and 260 respectively forces the engagement of the locking elements 258, 260 onto respective locking gears 80, 254, while operating the actuators 266 so that their piston moves away from the locking elements 258 and 260 respectively, forces the disengagement of the locking elements 258, 260 with respective locking gears 80, 254. The actuators 266 can be hydraulic, pneumatic, or electric.

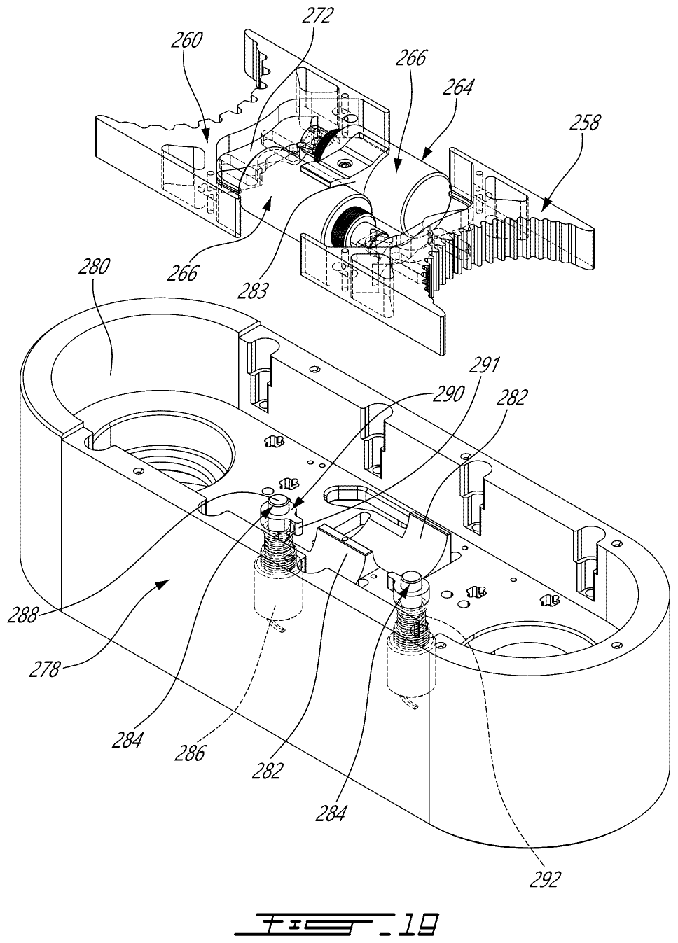

FIG. 17 shows the locking elements 258 and 260 in locking relationship with respective locking gears 80, 254, while FIG. 18 shows the locking elements 258 and 260 spaced apart from the locking gears 80 and 254.

To selectively maintain the first pivot locking mechanism 252 in its locked state/position shown in FIG. 19, the mechanism 252 further includes a pair of linear solenoids 284 that are mounted in the body 258 to act as locking pins.

With reference also to FIG. 19, each lock 284 includes a main cylindrical housing 286 inserted in the body 278, a pin 288 that is slidably mounted in the cylindrical housing 286 for movements in and out of the sliding course of the cooperating portion 272 of the locking elements 258, 260, a reinforcement ring 290 mounted to the body 278 about the pin 288 and including a reinforcement gusset 291, and a biasing member in the form of a spring 292 mounted to both the housing 286 and pin 288, about the pin 288, between the housing 286 and pin 288, for biasing the pin 288 towards its extended position beyond the ring 290.

The housing 286 conventionally includes an electromagnet (not shown) connect to the controller (not shown) for selectively pulling the pin 288 when it is energized so that it is completely withdrawn under within the ring 290.

As can be seen by comparing FIGS. 17 and 18, when the lock 284 is not energized, the pin 288 is forced in its extended position of Figured 17 by the spring 292, preventing the locking element 278, 280 from disengaging from the corresponding gear 80, 254 under the biasing force of the spring 128. When the lock 284 is energized, the pin 288 is withdrawn from the passage of the locking element 258, 260, allowing actuator 266 to disengage locking elements 258, 260.

One skilled in the art will appreciate that, contrarily to the first pivot locking assembly 36, which includes locking elements 94 and 96 that are movable in unison by a single cam assembly 100, the locking elements 258 and 260 of the first pivot locking assembly 252 are movable independently via respective actuators 266. Therefore, each locking elements 258 or 260, paired with an actuator 266 can be seen as an independent pivot locking assembly operating on a respective pivot assembly 22 and 28, operable independently to the other.

While such two independent pivot locking assemblies are illustrated in FIG. 1 as being identical, they can be different in structure and in operation.

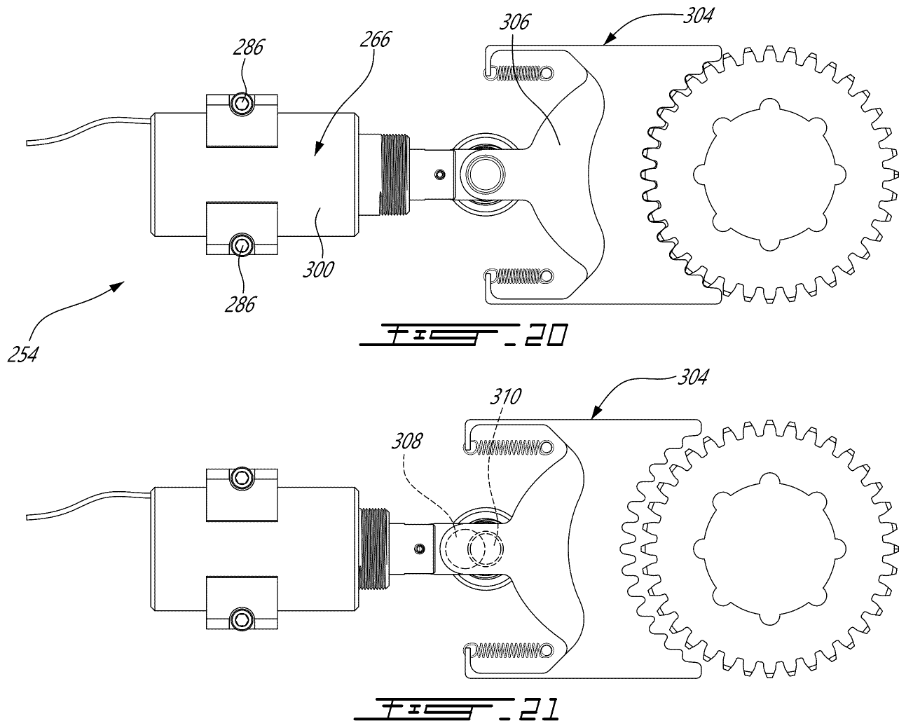

With reference to FIGS. 20-22, the second pivot locking mechanism 254 will now be described.

Since the second pivot locking assembly 254 is similar and operates similarly to the first pivot locking assembly 252, it will be described only briefly herein for concision purposes.

The main difference between the first and second pivot locking mechanisms 254 is that the mechanism 254 includes a single piston actuator 266 operatively coupled to a single locking element 312, since there is only one pivot assembly 33 to selectively lock.

To prevent any undesired movements in a direction different than the operative directions of the actuator 266, the housing body 294 is configured with a top side cavity 296 to guide locking element 304 and that includes a rounded receptacle 298 that is configured for complementary receiving the actuator 266 in a way that restrains its main body 300. Two clamps 302, that are shaped to be mounted on both lateral sides of the main body 300 is attached to the housing body 294 using fasteners 286.

The assembly 254 includes a locking element 304 that differs with the locking elements 258 and 260 by the shape of its cooperating portion 306 which is adapted for cooperating with a single actuator 266, and which is provided with a hole 308 configured to cooperate with the pin 310 of an electromagnetic lock 312. The lock 312 differs from the lock 284 by not including a reinforcement ring 290.

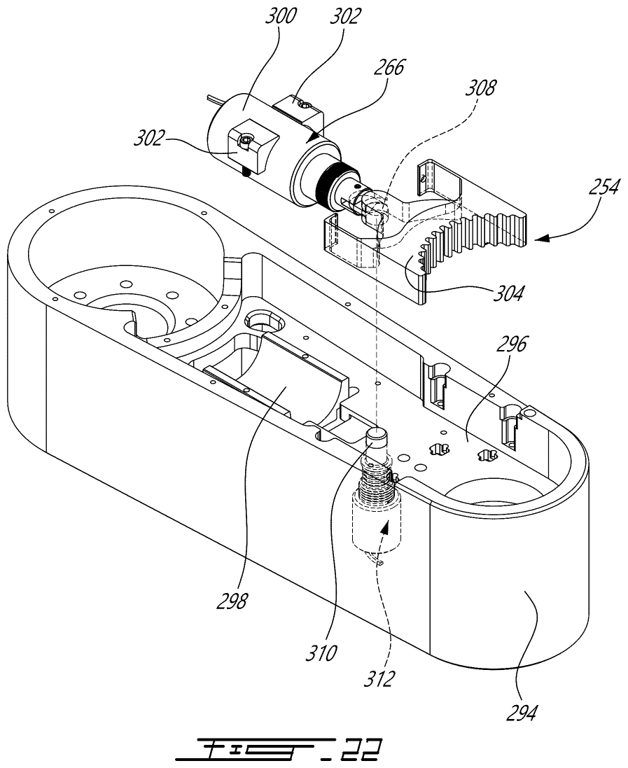

FIG. 20 shows the second pivot locking assembly 254 in its locked position, while FIG. 21 shows the assembly 254 in its unlocked position.

Since the operation of the second pivot locking assembly 254 is very similar to the operation of the first pivot locking assembly 252, it will not be described herein in more detail for concision purposes.

While the above-described embodiments have been described with reference to a controller for controlling the operation of the actuators described herein, more than one such controllers can be used. Since the configuration and operation of controllers for actuators are believed to be within the reach of a person skilled in the art, they will not be described herein in more detail for concision purposes.

It is to be understood that the multi-pivot seat base assembly is not limited in its application to the details of construction and parts illustrated in the accompanying drawings and described hereinabove. The multi-pivot seat base assembly is capable of other embodiments and of being practiced in various ways. It is also to be understood that the phraseology or terminology used herein is for the purpose of description and not limitation. Hence, although the multi-pivot seat base assembly has been described hereinabove by way of illustrative embodiments thereof, it can be modified, without departing from the spirit, scope and nature thereof.

1. A multi-pivot seat base assembly including:
a floor-mountable element;
a proximate arm having proximate and distal ends; the proximate arm being mounted to the floor-mountable element via its proximate end for first relative pivotal movement between the proximate arm and the floor-mountable element;
a distal arm having proximate and distal ends; the distal arm being mounted via its proximate end to the distal end of the proximate arm for second relative pivotal movement between the distal and proximate arms;
a seat-mounting element mounted to the distal arm at the distal end thereof for third relative pivotal movement between the distal arm and the seat mounting element;
a first pivot locking assembly associated with the proximate arm and being so configured as to selectively prevent the first relative pivotal movement;
a second pivot locking assembly associated with the distal arm and being so configured as to selectively prevent the third relative pivotal movement; and
a third pivot locking assembly associated with one of the proximate and distal arms and being so configured as to selectively prevent the second relative pivotal movement.

2. The multi-pivot seat base assembly as recited in claim 1, wherein the third pivot locking assembly is coupled with one of the first and second pivot locking assemblies for operation in unison, defining a dual pivot locking assembly.

3. The multi-pivot seat base assembly as recited in claim 1, further including a pivot linking mechanism so configured that a pivotal movement of the distal arm about the second pivot assembly causes a pivotal movement of the proximate arm about the first pivot assembly.

4. The multi-pivot seat base assembly as recited in claim 1, wherein the first, second and third pivot locking assemblies are in their locked position by default.

5. The multi-pivot seat base assembly as recited in claim 1, wherein at least one of the first, second and third relative pivotal movements is allowed by a pivot assembly including a shaft.

6. The multi-pivot seat base assembly as recited in claim 5, wherein each of the first, second and third relative pivotal movements are allowed by respectively, first, second and third pivot assemblies, each including a shaft.

7. The multi-pivot seat base assembly as recited in claim 6, wherein the proximate and distal arms include respective first and second bodies configured to allow the shafts therethrough.

8. The multi-pivot seat base assembly as recited in claim 6, wherein the shaft of the first pivot assembly is mounted to the floor-mountable element.

9. The multi-pivot seat base assembly as recited in claim 6, wherein the shaft of the third pivot assembly is mounted to the seat-mounting element.

10. The multi-pivot seat base assembly as recited in claim 6, further comprising an arm coupling assembly that links the first and second pivot assembly to cause the proximate and distal arms to pivot in unison.

11. The multi-pivot seat base assembly as recited in claim 6, wherein at least one of the first, second and third pivot assemblies includes at least one mechanical stop to limit the respective relative pivotal movement.

12. The multi-pivot seat base assembly as recited in claim 11, wherein the arm coupling assembly includes a first sprocket coupled to the first pivot assembly, a second sprocket coupled to the second pivot assembly, and a chain that links the first and second sprockets.

13. The multi-pivot seat base assembly as recited in claim 2, wherein the corresponding one of the first and third relative pivotal movements that is prevented by the dual locking assembly is allowed by a first pivot assembly that includes a first shaft; the second relative pivotal movement is allowed by a second pivot assembly that includes a second shaft; the dual locking assembly further comprising first and second locking elements that are movable in unison between i) a locking position, wherein the first and second locking elements prevent respectively the first and second shafts from pivoting, and ii) an unlocking position where the first and second shafts are pivotable, and an actuating mechanism that is associated with both first and second locking elements and that is selectively operable to move the first and second locking elements between the locking and unlocking positions.

14. The multi-pivot seat base assembly as recited in claim 13, wherein the dual pivot locking assembly further comprising a first gear mounted to the first shaft and a second gear mounted to the second shaft; the first and second locking elements each includes a portion that meshes with the corresponding first and second gears when the dual locking assembly is in its locking position.

15. The multi-pivot seat base assembly as recited in claim 13, wherein said dual pivot locking assembly further includes at least one biasing member mounted to both the first and second locking elements and the respective one of the proximate and distal arms therebetween for biasing both first and second locking elements towards the locking position.

16. The multi-pivot seat base assembly as recited in claim 13, wherein the actuating mechanism includes a pair of linear actuators, each associated with a respective one of the first and second locking elements.

17. The multi-pivot seat base assembly as recited in claim 16, wherein each of the linear actuators are associated with both the first, and second locking elements.

18. The multi-pivot seat base assembly as recited in claim 13, wherein the dual pivot locking assembly further includes at least one lock that is operable to selectively prevent the first, and second locking elements from moving towards the unlocking position.

19. The multi-pivot seat base assembly as recited in claim 18, wherein at least one lock is in the form of an electromagnetic lock.

20. The multi-pivot seat base assembly as recited in claim 18, wherein the at least one lock includes two locks, each associated with a respective one of the first and second locking elements.

21. The multi-pivot seat base assembly as recited in claim 1, wherein one of the first, second and third pivot locking assemblies includes a locking element that is movable towards and away from a locking position, where the locking element prevent the corresponding one of the first, second and third relative pivotal movement, and an actuating mechanism that is associated with the locking element to selectively move the locking element between the locking and unlocking positions.

22. The multi-pivot seat base assembly as recited in claim 21, wherein the actuating mechanism includes a linear or rotary actuator, associated with the locking element.

23. The multi-pivot seat base assembly as recited in claim 20, wherein said one of the first, second and third pivot locking assemblies further includes a lock that is operable to selectively prevent the locking element from moving towards the unlocking position.

24. The multi-pivot seat base assembly as recited in claim 23, wherein the lock is in the form of an electromagnetic lock.

25. The multi-pivot seat base assembly as recited in claim 23, wherein said one of the first, second and third pivot locking assemblies further includes at least one biasing member mounted to both the locking element and the respective one of the proximate and distal arms therebetween for biasing the locking element towards the locking position.

26. A seat provided with the multi-pivot seat base assembly according to claim 1.

27. (canceled)
